(19) United States
(12) Patent Application Publication
(10) Pub. No.: US 2006/0200814 A1
(43) Pub. Date: Sep. 7, 2006

(54) Software distribution with activation control

(75) Inventors: Kalevi Kontinen, Ostersundom (FI); Tapio Ypya, Perttula (FI); Heikki Melama, Vantaa (FI)

Correspondence Address: Hollingsworth & Funk, LLC;Suite 125, 8009 34th Avenue South, Minneapolis, MN, 55425, US

(73) Assignee: Nokia Corporation

(21) Appl. No.: 11/070,495

(22) Filed: Mar. 2, 2005

(51) Int. Cl. G06F 9/44

(52) U.S. Cl. 717/168

(57) ABSTRACT

Distributing software involves providing a software installation package configured to allow installing one or more programs on a computing arrangement. The software installation package is configured as a managed object compliant with the Open Mobile Alliance Device Management (OMA DM) specification. A certificate configured as a second managed object compliant with the OMA DM specification is also provided. One or more programs are installed to a computing arrangement using the software installation package. The one or more programs are bound to the computing arrangement using the certificate. Operation of the one or more programs is enabled based on the binding of the one or more programs to the computing arrangement.

### FIELD OF THE INVENTION

This invention relates in general to software, and more particularly to mechanisms for delivering and activating software.

### BACKGROUND OF THE INVENTION

In modem computer applications, it is becoming less common for a user to simply install software from a shrink-wrapped box or other distribution medium without further taking actions. Although many users still solely rely on this method for an installation, most sophisticated users realize that numerous patches must be applied to fix bugs that inevitably exist on shipped distributions. This is particularly true for complex software (e.g., operating systems) and software that interacts with public networks such as the Internet.

Complex software is never really finished. Most vendors who support their software will provide a continuous stream of fixes and improvements for some time after the initial versions have shipped. For example, a computer running a variant of the Windows™ operating system (OS) will not only have a particular version of Windows (e.g., Windows 2000, Windows XP™), but each versions will have had patches applied to bring the software to a certain fix level, such as by the application of service packs (e.g., SP1, SP2). Similarly, computers running a distribution of the GNU/Linux™ OS will have various versions of kernel, shells, daemons, windowing systems, etc., that will require occasional updating.

It is particularly important to continually upgrade software that accesses the Internet, because the Internet is the source of most malicious code that infects computers. For example, in 2004 it was estimated that a computer running an unpatched version of Windows XP would be compromised by a virus or other “malware” within 20 minutes of being connected directly to the Internet (e.g., connected without a hardware firewall). Therefore, in many applications constant updates are close to an absolute necessity.

Although the need for safe Internet connectivity often drives the constant application of patches, the Internet makes the application of such patches easier, especially for users having high bandwidth connections. The users can simply go to the software vendor's Web site and search for the latest updates. The users download the updates, which are often in the form of an executable file. After download, the users need only to run the downloaded file for the updates to be applied.

It is possible that, in some situations, a patch or update itself carries malicious software. This may occur, for example, where a user has been fooled into thinking a program is a patch from a trusted source, when in fact it is not. In other situations, a legitimate patch may be infected with malicious code, such as when a Web site has been compromised. Generally, the vendors who provide downloadable updates will take precautions to make sure that the updates themselves have not been compromised, and that the users can be assured that the updates come from a trusted source. Use of hash signatures and encryption keys can ensure that an update has not been tampered with. Also, certificate authorities can be used to make sure the Web page delivering the update is who they say they are.

It is not always the case that a software vendor can centrally distribute updates, however. For example, in mobile technologies such as cellular phones, Internet access may not always be available. Even if Internet access is available on the phone itself, it may be prohibitively expensive to use that access to download a major software update. A more practical solution is to have distributed entities, such as cellular service providers and network operators, push out updates. In this way, data transfer can be done efficiently by utilizing caching mechanisms and performing the data transfers during low-load operational periods of a cellular network.

By allowing software updates to originate from a plurality of sources, a software vendor can speed up the process of updates and reduce traffic on centralized servers. However, some software requires particularly stringent security measures. If compromised, such software could make the device completely non-operational, or at least so suspect as to be unsafe to use. Therefore, it is desirable to allow a vendor to ensure distributed software updates through third parties meet the same security standards as if the software originated from the vendor.

### SUMMARY OF THE INVENTION

The present disclosure relates to a system, apparatus and method for delivering software using activation controls. In one embodiment, a method of distributing software involves providing a software installation package configured to allow installing one or more programs on a computing arrangement. The software installation package is configured as a first managed object compliant with the Open Mobile Alliance Device Management (OMA DM) specification. A certificate configured as a second managed object compliant with the OMA DM specification is provided via a network. One or more programs are installed to a computing arrangement using the software installation package. The one or more programs are bound to the computing arrangement using the certificate. Operation of the one or more programs is enabled based on the binding of the one or more programs to the computing arrangement.

In more particular embodiments, the method may further involve causing the one or more programs to check for the existence of the binding during an execution time of the one or more programs. In one arrangement, installing the one or more programs may involve installing firmware. In another arrangement, providing the software installation package may involve downloading the software installation package to the computing arrangement via the network. The software installation package is may be downloaded from a third-party who is not a vendor of the software installation package. Enabling operation of the one or more programs may involve invoking an EXEC command on the second managed object.

In another embodiment of the invention, a processor-readable medium includes program storage device configured with instructions for causing a processor of a data processing arrangement capable of being coupled to a network to perform operations. The operations include receiving, via the network, a first identifier associated with a device and a second identifier associated with a software installation package. The software installation package is configured as a first managed object compliant with the Open Mobile Alliance Device Management (OMA DM) specification. The software installation package is used for installing a program on the device. The operations also involve forming, based on the first and second identifiers, a certificate for binding the program to the device. The certificate is configured as a second managed object compliant with the OMA DM specification. The certificate is sent to the device for purposes of enabling operation of the program on the device. The device may include a mobile terminal.

In another embodiment of the invention, a processor-readable medium includes program storage device configured with instructions for causing a processor of a data processing arrangement capable of being coupled to a network to perform operations of accessing a software installation package configured as a first managed object compliant with the Open Mobile Alliance Device Management (OMA DM) specification. A program is installed on the data processing arrangement using the software installation package. A certificate configured as a second managed object compliant with the OMA DM specification is retrieved via the network. The program is bound to the data processing arrangement using the certificate, and the program is enabled to operate on the data processing arrangement based on the binding of the program to the data processing arrangement.

In more particular embodiment of the invention, the operations further cause the program to check for the existence of the binding at a run time of the program. In one configuration, the data processing arrangement includes a mobile terminal.

In another embodiment of the invention, an apparatus includes a network interface capable of exchanging data via a network. A processor is coupled to the network interface. The apparatus includes a data storage arrangement comprising a certificate generation program. The certificate generation program has instructions that cause the processor to receive, via the network, a first identifier associated with a device and a second identifier associated with a software installation package. The software installation package is configured as a first managed object compliant with the Open Mobile Alliance Device Management (OMA DM) specification. The software installation package is capable of installing a program on the device. The instructions further cause the processor to form, based on the first and second identifiers, a certificate for binding the program to device. The certificate is configured as a second managed object compliant with the OMA DM specification. The certificate is sent to the device for purposes of enabling operation of the program on the device.

In another embodiment of the invention, an apparatus includes a network interface capable of exchanging data via a network. A processor is coupled to the network interface. The apparatus includes a data storage arrangement comprising a software installation package configured as a first managed object compliant with the Open Mobile Alliance Device Management (OMA DM) specification. The software installation program has instructions that cause the processor to: install a program on the apparatus; retrieve, via the network, a certificate configured as a second managed object compliant with the OMA DM specification; bind the program to the apparatus using the certificate; and enable the program to operate on the apparatus based on the binding of the program to the apparatus.

In another embodiment of the invention, a system, includes: means for providing a software installation package configured as a first managed object compliant with the Open Mobile Alliance Device Management (OMA DM) specification; means for providing a certificate configured as a second managed object compliant with the OMA DM specification; means for installing the one or more programs to a computing arrangement using the software installation package; means for binding the one or more programs to the computing arrangement using the certificate; and means for enabling the program to operate on the computing arrangement based on the binding of the one or more programs to the computing arrangement.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of a system, apparatus, and method in accordance with the invention.

### BRIEF DESCRIPTION OF THE DRAWINGS

The invention is described in connection with the embodiments illustrated in the following diagrams.

FIG. 1 is a flowchart that illustrates a software delivery procedure according to embodiments of the present invention;

FIG. 2 illustrates an arrangement for delivering software updates in an OMA DM environment according to embodiments of the present invention;

FIG. 3 is a flowchart that illustrates software delivery and activation according to embodiments of the present invention;

FIG. 4 shows a system for delivering software according to embodiments of the present invention;

FIG. 5 shows a terminal enabled to receive software updates according to embodiments of the present invention; and

FIG. 6 shows a computing structure for providing device specific certificates according to embodiments of the present invention.

### DETAILED DESCRIPTION OF THE INVENTION

In the following description of various exemplary embodiments, reference is made to the accompanying drawings that form a part hereof, and in which is shown by way of illustration various embodiments in which the invention may be practiced. It is to be understood that other embodiments may be utilized, as structural and operational changes may be made without departing from the scope of the present invention.

Generally, the present disclosure is directed to mechanisms for providing software and software updates to computing apparatuses. Although the mechanisms described herein are suitable for any computing apparatus, they may be particularly well suited for mobile devices such as cellular phones, Personal Digital Assistants (PDA), and the like. Such devices may be able to download software from one or more third parties via a wireless connection. The third parties may include network operators, service providers, enterprise managers, and any other entity that can offer the update in a distributed fashion. Before activation of the software, a device-specific certificate is generated that is used to activate the device. Typically the certificate is generated at a centralized location, such as at a server maintained by the device vendor. The device receives the certificate before activation, and when activation is commenced, the certificate is used to bind the software to the particular device. The software may include its own certificates for purposes such as verifying data integrity and source.

As previously mentioned, the concepts described herein in relation to downloading-and activating software are applicable to any type of communication systems, devices, and networks. In order to facilitate an understanding of the invention, the present invention may be described in the context of mobile devices in a wireless networking environment. It will be appreciated, however, that the invention may be applicable in any system or application where reliably delivering software to data processing devices is desired.

Although there exists a wide variety of electronic devices that utilize software, there are particular challenges to providing software in the realm of mobile electronics. Most mobile devices are primarily communications devices. Therefore, the usefulness of such devices depends as much on the communication infrastructures as on the device itself. Network operators and service providers play an important role in deciding which devices will be supported on their networks. Similarly, communications devices may be required to work across multiple networks and environments around the world. In response to these requirements, the Open Mobile Alliance (OMA) was formed to promote services and that are interoperable across countries, network operators, and devices.

The OMA delivers open specifications for use by the mobile communications industry. These specifications define a baseline set of services and interfaces that can be adopted by service providers and manufacturers in the industry. The OMA has specifications covering a wide range of technical areas, including messaging, commerce/billing, browsers, push-to-talk, etc. Of interest in the field of software updates is the OMA Device Management (DM) specification.

The OMA DM provides a standardized approach to managing device configuration data, capabilities, software installation/update, device diagnostics, access rights management, and other task related to configuring mobile devices. The software management aspects of DM include the installation, removal, upgrade of application and non-application software. Non-application software includes, but is not limited to, firmware, operating systems, drivers, and radio software.

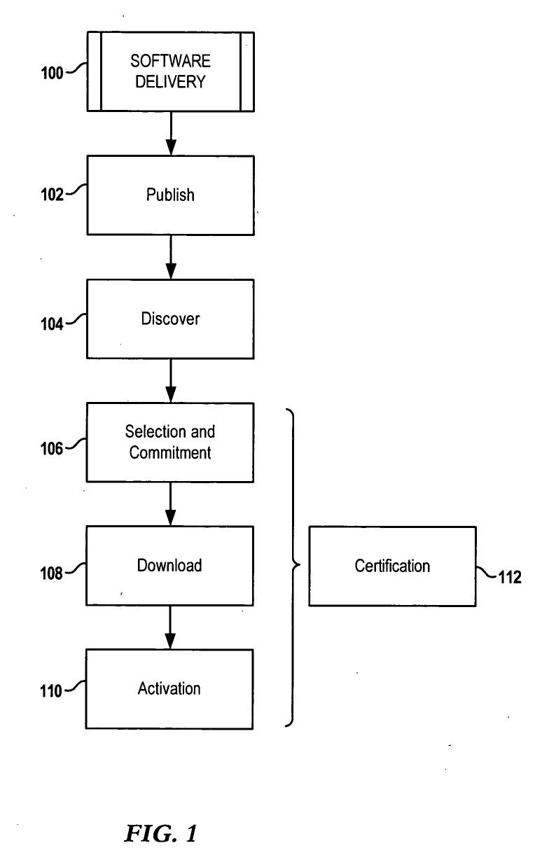

The DM provides a mechanism for manufacturers to automatically update application and non-application software to correct defects and provide improvements. The present disclosure describes delivering software in OMA DM using activation controls in a way that gives software copyright owners an enhanced mechanism for controlling use while simultaneously keeping a system fully transparent and OMA DM compliant. A simplified OMA DM software delivery process 100 adapted according to embodiments of the present invention is shown in FIG. 1. First, the manufacturer will publish (102) software, either as a full install image or an incremental upgrade. The device will discover (104) the published software, either using a manual search, automatic notification, or other means known in the art.

After discovery (104), the device must select and commit (106) to the download. This may involve verifying the correct versions and other checks. The selection and commitment (106) may occur automatically or as a result of user interaction. In either case, once the software is selected, a download (108) may commence. When download is complete, the software is activated (110).

Activation (110) of the software may include running installation programs/scripts, verifying integrity (e.g., hash comparisons), accepting end-user license agreements, setting run-time options/configurations, and any other action that may be required to put the software in condition for use. After activation (110), the software is typically ready to use. In some instances, this may require restarting some or all system software. In particular, a operating or firmware revision will require rebooting the hardware.

In cases where critical system software or firmware has been selected (106), downloaded (108), and activated (110), it is important these steps have not been compromised. If the wrong software/firmware is mistakenly or intentionally installed, the device may refuse to work properly, if at all. If the wrong software was installed, this may be caught at activation phase, but this is not always guaranteed. Similarly, if the software was compromised, this may not be caught during activation, and could result in an inoperative or compromised device.

In order to better protect critical software that is distributed by third parties, the device vendor can institute a certification (112) that occurs prior to or during activation (110). The certification (112) process generally involves connecting to a trusted system and retrieving a certificate that is unique to the device on which the software is to be installed. The certificate may be stored on the trusted system for retrieval, or may be dynamically generated at the trusted system. The entity hosting the trusted system may include the hardware vendor, software vendor, or a trusted third party such as a certificate authority.

A particular application for which the present invention is suitable includes mobile services conforming to OMA DM specifications. The OMA DM provides, among other things, a uniform way to manage persistent data objects used in configuring, operating, and updating device software. One class of data objects used in OMA DM is referred to as management objects. A management object is a logical entity used to manage configurable software and data within a device. The configurable software may include firmware, operating system components, drivers, modules, applications, executable objects (e.g., applets), scripts, etc. The data managed by a management object may include user preferences, address books, proxy settings, connectivity parameters, user presence and identity data, etc.

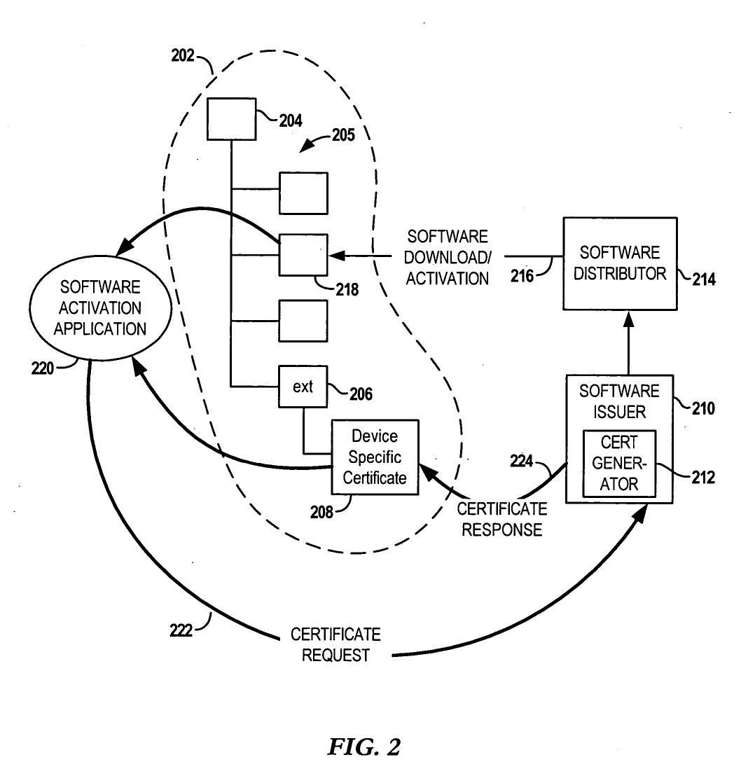

All management objects should support a baseline set of operations. These operations include add/install, replace/update, delete/uninstall, and query/enumerate. More specific management objects may support a more extensive set of operations. One set of management objects of interest to the present disclosure are known as firmware update management objects. An implementation of firmware management object 202 and associated infrastructure according to embodiments of the present invention is shown in FIG. 2. A firmware management object 202 is associated with firmware updates in the OMA DM environment. The firmware management object 202 is arranged under an internal node 204 of the object's management object tree 205.

Node 204 acts as a placeholder for the name of a particular firmware update package. The subnodes of the tree 205 may contain such nodes as Download, Update, State, etc. Nodes of the firmware management object 202 may have certain associated behaviors, such as the implementation of the EXEC and/or REPLACE commands on particular nodes of the tree 205. In the illustrated firmware management object 202, an optional node “Ext” 206 is implemented. The Ext node 206 is used for supporting vendor specific extensions. The Ext node 206 in this example contains a managed object designated as a device specific certificate 208.

The device specific certificate 208 serves some or all of the functions of the rights object 212 shown in FIG. 2. This certificate 208 is obtained from a software issuer 210. In this example, the certificate 208 may be dynamically created by a certificate generator component 212. The generator component 212 may be part of the service infrastructure of the software issuer 210, or may be a trusted third party. In either case, the software issuer 210 has control over the issuance of certificates 208 from the generator component 212.

In one scenario, the software issuer 210 distributes at least some of the software (in this example a firmware upgrade) via a distributor 214, as indicated by the path 216. The software distributor 214 may have a business alliance with the issuer 210, but this is not necessarily required. For example, the software may be disseminated via a peer-to-peer network, where one or more entities are untrusted. Even if part of the download path includes untrusted elements, the distribution methodology includes safeguards to prevent corrupted software from being used.

In an OMA DM environment, the download activity 216 may be initiated by using the REPLACE command on an appropriate object node 218 of the firmware management tree 205. The object node 218 may include, for example, a Download or DownloadAndUpdate management object. After download is complete, the upgrade may be activated by running the EXEC command on the object 218. This will typically result in instructions, as represented by the activation application 220, being executed on the device.

As part of the activation phase, the activation application 220 may initiate a certificate request 222 from the software issuer 210. In response, the issuer 210 may directly or indirectly generate a certificate and send the certificate to the device as indicated by the path 224. The response 224 may involve running a REPLACE and/or EXEC command on the device specific certification object 208. The activation application 220 can then use the device specific certificate object 208 in binding the upgrade to this particular device.

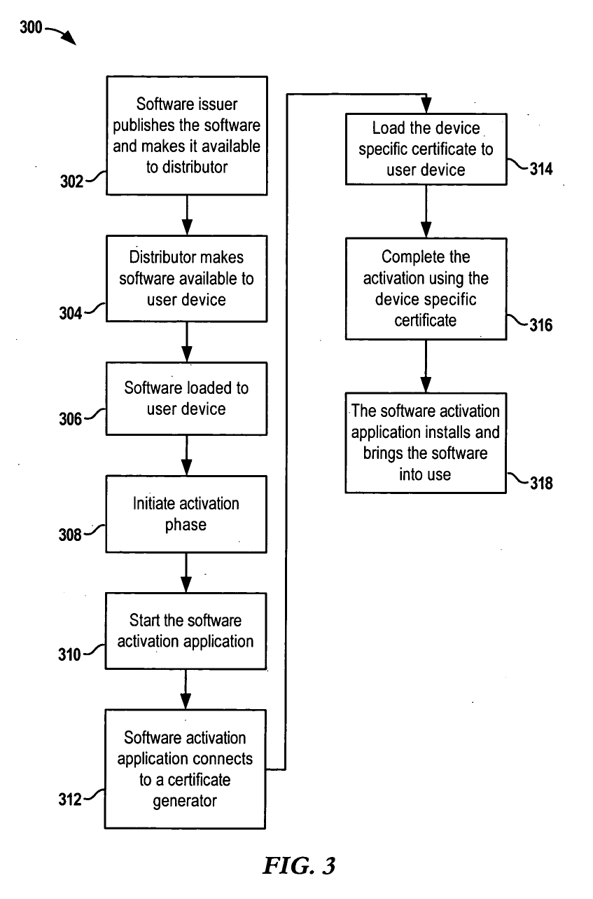

The procedures involved in delivering software in an OMA DM environment (or similar environment) according to embodiments of the present invention are shown in a flowchart 300 in FIG. 3. The software issuer publishes (302) the software thereby making the software available at least to a distributor. The distributor makes the software available (304) to the user. The software may be made publicly available, or made available to select users that have a relationship with the distributor, such as subscribers to an operator's network. Whatever means are used to make the software available (304), it can then be loaded (306) to the user device.

After the software has been uploaded (306), an activation phase is initiated (308). The activation may be initiated (308) by the distributor or the user. For example, the distributor may send an EXEC command to a managed data object that was received during the software load (306). Part of the activation process involves starting (310) an application used for automating the activation process. The activation application connects (312) to a certificate generator. This results in a device specific certificate being loaded (314) to the user device. In an OMA DM compliant terminal, loading (314) the certificate may involve using a REPLACE command on a certificate object in the DM management tree.

After the device specific certificate is loaded (314), the activation may be completed (316) using the device specific certificate. Completing the activation (316) may involve, for example, extracting a cryptographic key from the certificate and using that key to decrypt portions of the downloadable software package. In other arrangements, the certificate may be used to enable further operation of the software activation program. The device specific certificate may include any combination of data files and executable files. In an OMA DM compliant terminal, the executable files may be included as a managed object and activated by use of the EXEC command. After the activation program has successfully utilized (316) the certificate, the software can be enabled (318) for use. The software may be immediately started and/or placed in a position to be started on the occurrence of some event, such as a device reboot.

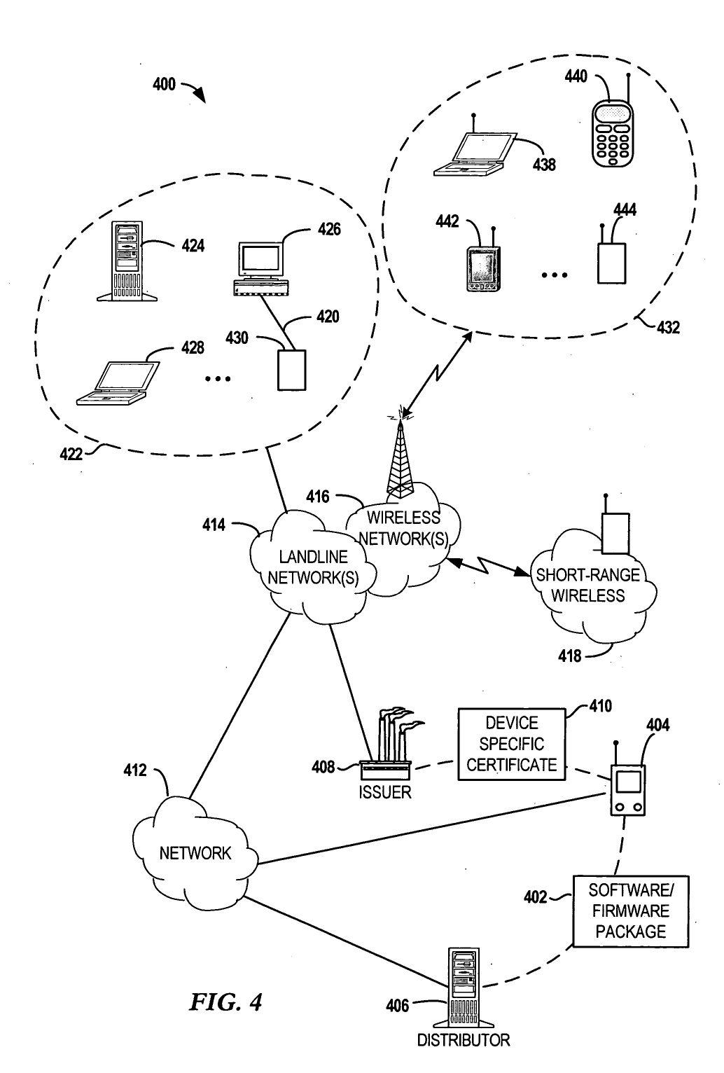

Although some aspects of software delivery have been discussed in terms of a mobile terminal, the concepts described herein may be applied across a wide range of technologies. FIG. 4 illustrates a system 400 capable of distributing software according to embodiments of the present invention. Generally, the system 400 includes a target data processing device for receiving software and/or firmware packages 402. The target device is represented as a mobile terminal 404, although any manner of device may be the target device. The software/firmware 402 is distributed via a distributing entity 406. A software issuer 408 is typically the originator of the software/firmware 402, and the issuer 408 (or an agent of the issuer 408) is configured to provide a device specific certificate 410 to the target device 404. The certificate 410 is used to enable activation of the software/firmware package 402 on the target device 404.

The terminal 404, distributor 406, and issuer 408 may be coupled by one or more networks, as represented by generic network 412. These networks may include landline network(s) 414, which may include a Global Area Network (GAN) such as the Internet, one or more Wide Area Networks (WAN), Local Area Networks (LAN), and the like. The networks may also include one or more wireless networks 416, such as Global System for Mobile Communications (GSM), Universal Mobile Telecommunications System (UMTS), Personal Communications Service (PCS), Time Division Multiple Access (TDMA), Code Division Multiple Access (CDMA), or other mobile network transmission technology. Devices may also communicate using short-range wireless technologies 418, such as Bluetooth, Wireless Local Area Network (WLAN), infrared (IR), etc. Data may also be distributed using direct-wired connections, such as depicted by connection path 420. The present invention is applicable regardless of the manner in which data is provided or distributed between the target devices.

Similarly, the roles of terminal 404, distributor 406, and issuer 408 may be carried out on any data processing arrangement known in the art. Such devices include traditional computing devices 422, such as servers 424, desktop computers 426 or workstations, laptop or other portable computers 428, or any other similar computing device capable of network communications, as represented by generic device 430. Other devices that can incorporate software distribution technologies according to the present invention include mobile devices 432, such as laptop or other portable computers 438, mobile phones 440 and other mobile communicators, Personal Digital Assistants (PDA) 442, or any other similar computing device capable of communicating via the wireless network 416, as represented by generic mobile device 444.

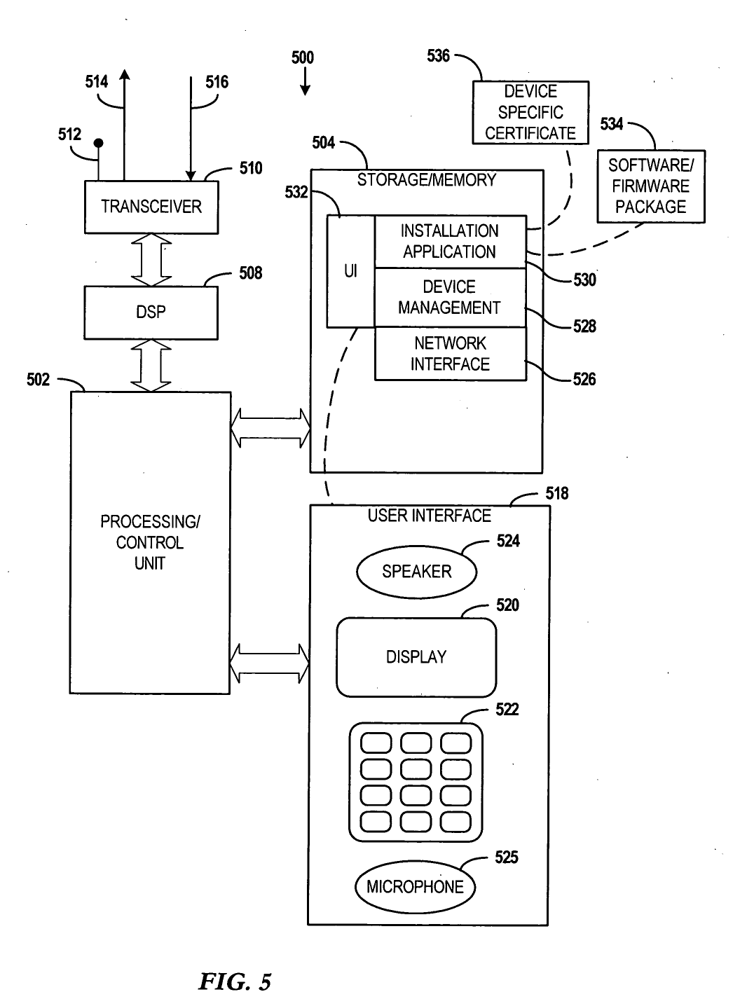

An example of a target device that utilizes software delivery services according to embodiments of the present invention is illustrated in FIG. 5 as the mobile computing arrangement 500. Those skilled in the art will appreciate that the exemplary mobile computing arrangement 500 is merely representative of general functions that may be associated with such mobile devices, and also that landline computing systems similarly include computing circuitry to perform such operations.

The mobile computing arrangement 500 is suitable for processing one or more software/firmware installations in accordance with embodiments of the present invention. The software/firmware may be an initial installation and/or an upgrade to an existing installation. The representative mobile computing arrangement 500 includes a processing/control unit 502, such as a microprocessor, reduced instruction set computer (RISC), or other central processing module. The processing unit 502 need not be a single device, and may include one or more processors. For example, the processing unit 502 may include a master processor and associated slave processors coupled to communicate with the master processor.

The processing unit 502 controls the basic functions of the mobile computing arrangement 500. Those functions associated may be included as instructions stored in a program storage/memory 504. The program storage 504 may include one or more of read-only memory (ROM), flash ROM, programmable and/or erasable ROM, random access memory (RAM), subscriber interface module (SIM), wireless interface module (WIM), smart card, or other removable memory device.

In one embodiment of the invention, the program modules associated with the storage/memory 504 are stored in non-volatile electrically-erasable, programmable ROM (EEPROM), flash ROM, etc. so that the information is not lost upon power down of the mobile computing arrangement 500. The relevant software for carrying out conventional mobile terminal operations and operations in accordance with the present invention may also be transmitted to the mobile computing arrangement 500 via data signals, such as being downloaded electronically via one or more networks, such as the Internet and an intermediate wireless network(s).

The processing/control unit 502 includes circuitry for performing wireless data transmissions. This circuitry may include a digital signal processor (DSP) 508 employed to perform a variety of functions, including analog-to-digital (A/D) conversion, digital-to-analog (D/A) conversion, speech coding/decoding, encryption/decryption, error detection and correction, bit stream translation, filtering, etc. A transceiver 510, generally coupled to an antenna 512, transmits the outgoing radio signals 514 and receives the incoming radio signals 516 associated with the wireless device 500.

The processor 502 is also coupled to user-interface elements 518 associated with the mobile terminal. The user-interface 518 of the mobile terminal may include, for example, a display 520 such as a liquid crystal display, a keypad 522, speaker 524, and microphone 525. These and other user-interface components are coupled to the processor 502 as is known in the art. Other user-interface mechanisms may be employed, such as voice commands, switches, touch pad/screen, graphical user interface using a pointing device, trackball, joystick, or any other user interface mechanism.

In one arrangement, the program storage/memory 504 includes software modules such as a network interface module 526, a device management module 528, an installation application 530, and a user interface (UI) module 532. The network interface 526 may include drivers and other software components for communicating with circuitry coupled to the processing/control unit 502 for performing wireless data transmissions. The device management module 528 allows configuration and management of the device 500 via the UI module 532 and the network interface 526. The device management module 528 may accept user inputs from the UI module 532 for setting up local preferences and options. The device management module 528 may use the network interface 526 for uploading/downloading configuration data for use on the device 500.

One example of data that is managed by the device management module 528 is a downloadable software/firmware package 534. The software/firmware package 534 may contain any combination of application software, OS software components, firmware, and data. The package 534 may contain an entirely new set of instructions (e.g., an entire firmware image, a new application) or the package 534 may contain updates to existing software/firmware on the computing arrangement 500. Generally the software/firmware package 534 is downloaded via the network interface 526, although the package 534 may be received via other methods, such as removable media, direct wired connections, infrared connections, ROM chips, etc.

To install the software/firmware package 534, the device management module 528 may utilize the installation application 530. The installation application 530 may permanently reside on the computing arrangement 500, or may be provided as part of the software/firmware package 534. The installation application 530 utilizes instructions for installing/upgrading software and/or firmware.

The installation application 530 may indirectly or directly access the network interface 526 for downloading a device specific certificate 536. The device specific certificate 536 is a data package that can be used to bind the software/firmware package 534 to a particular computing arrangement 500. The certificate 536 may be generated using any combination of identifiers associated with the software/firmware package 534 and identifiers associated with the computing arrangement 500. An example of identifiers associated with the software/firmware package 534 may include a PKI key, version numbers, binary hash of the package 534, source URL, package name, etc. Identifiers associated with the arrangement 500 may include processor ID, MAC address, user ID, user name, smart card keys, user passwords, etc.

By binding the device specific certificate 536 to the computing arrangement 500, the installation application 530 can complete the installation of the software/firmware package 534. The binding may involve a one-time check of the certificate 536 at installation time. The binding may also be verified by the installed software/firmware each time the software/firmware executes. By using the device specific certificate 536 when initializing and/or running the installed software, the originator of the software can ensure compatibility, track the number of installations, ensure user authorization, and ensure integrity of the distributed packages 534.

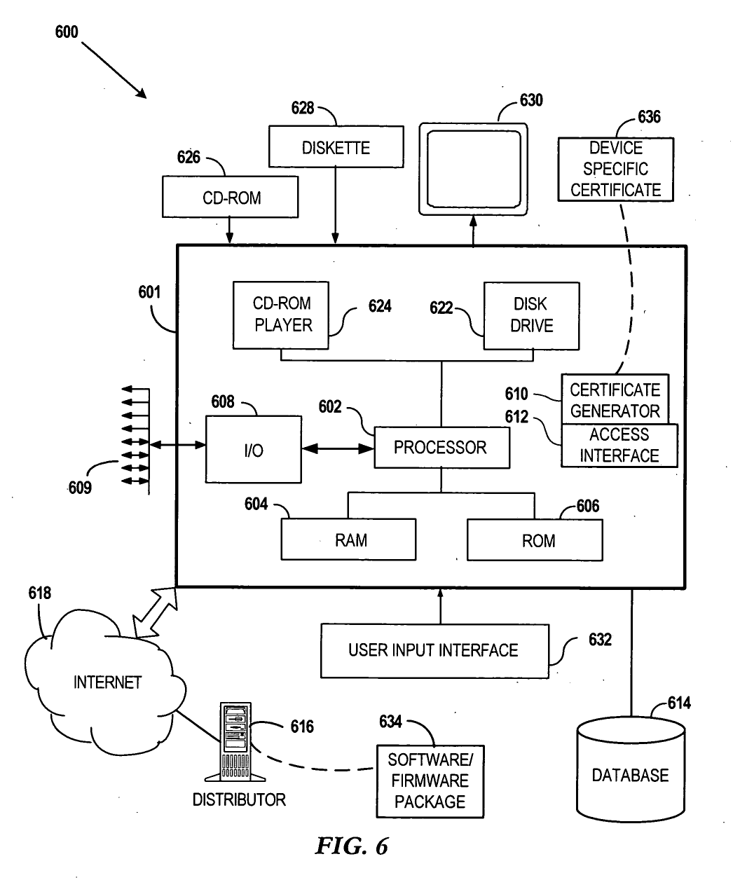

The device specific certificate 536 may be issued at the time the package 534 is downloaded, when the packages 534 is activated by the installation software 530, and any other time up until the time it is required. The device specific certificate 536 is generally issued from a network entity accessible by the computing arrangement 500. Example network entities used to distribute software/firmware packages 534 and issue certificates 536 according to embodiments of the present invention is shown as the computing structure 600 of FIG. 6. The computing structure 600 is used for issuing device specific certificates 536 in conjunction with, for example, third-party software distribution.

The example computing structure 600 suitable for performing the software in includes a computing arrangement 601. The computing arrangement 601 may act a server, client, gateway, proxy, or any other network entity used for processing and delivering the device specific certifications 536. The computing arrangement 601 includes a central processor (CPU) 602 coupled to random access memory (RAM) 604 and read-only memory (ROM) 606. The ROM 606 may also include other types of storage media to store programs, such as programmable ROM (PROM), erasable PROM (EPROM), etc. The processor 602 may communicate with other internal and external components through input/output (I/O) circuitry 608 and bussing 609, to provide control signals and the like.

The memory of the computing arrangement 601 may be used to store processor executable instructions for carrying out various tasks related to secure software distribution. For example, processing of requests for device specific certificates 536 via a certificate generator module 610 and an access interface 612. The access interface 612 may be network coupled to receive requests for certificates 534 usable for activating software/firmware packages 534. These requests can be passed to the certificate generator module 610 for generation of the certificates 536. The certificate generator module 610 may use any combination of algorithms, to generate one or more unique identifiers used to bind the software/firmware package 534 to a particular device. The certificate 536 that is thereby generated can be sent to the recipient via the access interface 612.

The certificate generator module 610 typically receives some identification data from a requesting entity. This identification data may be used to directly create the device specific certificate 536. For example, the certificate generator module 610 could use a public PKI key of the requesting device to create and encrypted value used to activate the software. The requesting device could use its private PKI key to extract this value use it to activate and run the software. In another example, the certificate generator module may access a database 614 that contains predetermined certificates for requesting entities. These predetermined certificates may be securely stored by the product manufacturer in order to track and verify updates to particular combinations of hardware and software components used in client devices.

The computing arrangement 601 generally provides activation control over software/firmware 634 provided by a distributor entity 616. The distributor entity 616 is typically a third party, although the functionality of the distributor 616 may be provided by the same party that provides the certificate generator 610. The distributor 616 may even be incorporated into the computing arrangement 601 that includes the certificate generator software 610. The computing arrangement 601 and distributor entity 616 do not necessarily need to be coupled via a network in order for the software activation to work as described. In some cases, however, the certificate generator 610 may use an identifier (e.g., URL) of the distributor 616 in order to determine whether or not to provide a device specific certificate 536.

The computing arrangement 601 may also include one or more data storage devices, including hard and floppy disk drives 622, CD-ROM drives 624, and other hardware capable of reading and/or storing information such as DVD, etc. In one embodiment, software for carrying out the operations in accordance with the present invention may be stored and distributed on a CD-ROM 626, diskette 628 or other form of media capable of portably storing information. These storage media may be inserted into, and read by, devices such as the CD-ROM drive 624, the disk drive 622, etc. The software may also be transmitted to computing arrangement 601 via data signals, such as being downloaded electronically via a network, such as the Internet 618. The computing arrangement 601 may be coupled to a display 630, which may be any type of known display or presentation screen, such as LCD displays, plasma display, cathode ray tubes (CRT), etc. A user-input interface 632 may be provided, including one or more user interface mechanisms such as a mouse, keyboard, microphone, touch pad, touch screen, voice-recognition system, etc.

The computing arrangement 600 of FIG. 6 is provided as a representative example of a computing environment in which the principles of the present invention may be applied. From the description provided herein, those skilled in the art will appreciate that the present invention is equally applicable in a variety of other currently known and future mobile and landline computing environments. For example, desktop computing devices similarly include a processor, memory, a user interface, and data communication circuitry. Thus, the present invention is applicable in any known computing structure where data may be communicated via a network.

Hardware, firmware, software or a combination thereof may be used to perform the various functions and operations described herein of a distributed-computation program. Articles of manufacture encompassing code to carry out functions associated with the present invention are intended to encompass a computer program that exists permanently or temporarily on any computer-usable medium or in any transmitting medium, which transmits such a program. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links. From the description provided herein, those skilled in the art will be readily able to combine software created as described with appropriate general purpose or special purpose computer hardware to create a distributed-computation system, apparatus, and method in accordance with the present invention.

The foregoing description of the exemplary embodiments of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather defined by the claims appended hereto.

What is claimed is:

1. A method of distributing software, comprising:
providing a software installation package configured as a first managed object compliant with the Open Mobile Alliance Device Management (OMA DM) specification to a computing arrangement;
providing, via a network, a certificate configured as a second managed object compliant with the OMA DM specification to the computing arrangement;
installing one or more programs to the computing arrangement using the software installation package;
binding the one or more programs to the computing arrangement using the certificate; and
enabling operation of the one or more programs based on the binding of the one or more programs to the computing arrangement.

2. The method of claim 1, further comprising causing the one or more programs to check for the existence of the binding during an execution time of the one or more programs.

3. The method of claim 1, wherein installing the one or more programs comprise installing firmware.

4. The method of claim 1, wherein providing the software installation package comprises downloading the software installation package to the computing arrangement via the network.

5. The method of claim 4, wherein downloading the software installation package comprises downloading the software installation package from a third-party who is not a vendor of the software installation package.

6. The method of claim 1, wherein enabling operation of the one or more programs comprises invoking an EXEC command on the second managed object.

7. A processor-readable medium, comprising:
a program storage device configured with instructions for causing a processor of a data processing arrangement capable of being coupled to a network to perform the operations of,
receiving, via the network; a first identifier associated with a device and a second identifier associated with a software installation package that is configured as a first managed object compliant with the Open Mobile Alliance Device Management (OMA DM) specification, the software installation package used for installing a program on the device;
forming, based on the first and second identifiers, a certificate for binding the program to the device, the certificate configured as a second managed object compliant with the OMA DM specification; and
sending the certificate to the device for purposes of enabling operation of the program on the device.

8. The processor-readable medium of claim 7, further comprising, after sending the certificate to the device, invoking an EXEC command on the second managed object to activate the program of the software installation package.

9. The processor-readable medium of claim 7, wherein the device comprises a mobile terminal.

10. The processor-readable medium of claim 7, wherein the program comprises a firmware image.

11. A processor-readable medium, comprising:
a program storage device configured with instructions for causing a processor of a data processing arrangement capable of being coupled to a network to perform the operations of,
accessing a software installation package configured as a first managed object compliant with the Open Mobile Alliance Device Management (OMA DM) specification;
installing a program on the data processing arrangement using the software installation package;
retrieving, via the network, a certificate configured as a second managed object compliant with the OMA DM specification;
binding the program to the data processing arrangement using the certificate; and
enabling the program to operate on the data processing arrangement based on the binding of the program to the data processing arrangement.

12. The processor-readable medium of claim 11, wherein the operations further comprise causing the program to check for the existence of the binding at a run time of the program.

13. The processor-readable medium of claim 11, wherein the data processing arrangement comprises a mobile terminal.

14. The processor-readable medium of claim 11, wherein the program comprises a firmware image.

15. The processor-readable medium of claim 11, wherein the operations further comprise downloading the software installation package to the data processing arrangement via the network.

16. The processor-readable medium of claim 15, wherein the software installation package is downloaded from a third-party who is not a vendor of the software installation package.

17. The processor-readable medium of claim 11, enabling the program to operate on the data processing arrangement comprises invoking an EXEC command on the second managed object.

18. An apparatus, comprising:
a network interface capable of exchanging data via a network;
a processor coupled to the network interface; and
a data storage arrangement comprising,
a certificate generation program having instructions that cause the processor to,
receive, via the network, a first identifier associated with a device and a second identifier associated with a software installation package that is configured as a first managed object compliant with the Open Mobile Alliance Device Management (OMA DM) specification, the software installation package capable of installing a program on the device;
form, based on the first and second identifiers, a certificate for binding the program to device, the certificate configured as a second managed object compliant with the OMA DM specification; and
send the certificate to the device for purposes of enabling operation of the program on the device.

19. The apparatus of claim 18, wherein the certificate generation program further causes the processor to, after sending the certificate to the device, invoke an EXEC command on the managed object to activate the program of the software installation package.

20. An apparatus, comprising:
a network interface configured to exchange data via a network;
a processor coupled to the network interface; and
a data storage arrangement comprising,
a software installation package configured as a first managed object compliant with the Open Mobile Alliance Device Management (OMA DM) specification, the software installation program having instructions that cause the processor to
install a program on the apparatus;
retrieve, via the network, a certificate configured as a second managed object compliant with the OMA DM specification;
bind the program to the apparatus using the certificate; and
enable the program to operate on the apparatus based on the binding of the program to the apparatus.

21. The apparatus of claim 20, wherein the apparatus comprises a mobile terminal.

22. The apparatus of claim 20, wherein the program comprises a firmware image.

23. A system, comprising:
means for providing a software installation package configured as a first managed object compliant with the Open Mobile Alliance Device Management (OMA DM) specification;
means for providing a certificate configured as a second managed object compliant with the OMA DM specification;
means for installing the one or more programs to a computing arrangement using the software installation package;
means for binding the one or more programs to the computing arrangement using the certificate; and
means for enabling the program to operate on the computing arrangement based on the binding of the one or more programs to the computing arrangement.
